(19) United States
(12) Patent Application Publication
(10) Pub. No.: US 2009/0201671 A1
(43) Pub. Date: Aug. 13, 2009

(54) Illuminated Backpack

(76) Inventor: James Huntley, Hollywood, CA (US)

Correspondence Address: QUICKPATENTS, INC., 32861 CALLE PERFECTO, SUITE A, SAN JUAN CAPISTRANO, CA, 92675, US

(21) Appl. No.: 12/027,941

(22) Filed: Feb. 7, 2008

(51) Int. Cl. F21V 21/108; A45C 15/06

(52) U.S. Cl. 362/108; 362/156; 224/576

(57) ABSTRACT

The present device is a stimulating wearable item that provides safety and entertainment benefits to the wearer. The device includes a wearable item, preferably a backpack, a stimulus control system, and at least one stimulus means. The stimulus control system includes a controller, a motion sensor and at least one power source. Each stimulus means is electrically connected to the stimulus control system. When the controller detects movement of the wearable item through the motion sensor, the stimulus control system activates the at least one stimulus means. The at least one stimulus means includes different stimulus means, such as a noise means, a vibration means, or an illumination means. The stimulating wearable item uses multiple stimulating means to increase the profile of the wearer and is enjoyable to wear to encourage frequent use. The device also allows for easy changing of the stimulus means as desired.

### CROSS-REFERENCE TO RELATED APPLICATIONS

This application claims the benefit of my US Provisional patent application filed on Feb. 8, 2007, incorporated herein by reference, and of my US Provisional patent application filed on May 7, 2007, also incorporated herein by reference.

### STATEMENT REGARDING FEDERALLY SPONSORED RESEARCH AND DEVELOPMENT

Not Applicable.

### FIELD OF THE INVENTION

This invention relates to wearable items, and more particularly to stimulating wearable items.

### BACKGROUND OF THE INVENTION

Pedestrian safety is becoming more and more important in urban areas. Not only is it important for a person on foot to be noticeable to drivers after dark, it is equally important that they draw attention to themselves during the daytime if traveling in busy urban areas with heavy traffic. This is especially important when it comes to children traveling as the sun begins to set or adults exercising after dark. The above safety concerns in urban areas also applies to pets.

Numerous means exist to bring attention to a pedestrian. A common approach is to increase the visibility of pedestrians. This approach includes using bright colors, reflective material, and powered illumination devices. The prior art has a wide variety of items that incorporate these approaches to increase visibility. Very often these items are wearable to provide a pedestrian the convenience of a hands-free device to improve visibility. Many such wearable items comprise of non-powered, mainly reflective material. Using a wearable item with a powered illumination device can provide a pedestrian greater visibility than a non-powered device.

Powered illumination devices typically provide a constant-on setting or provide a constant-blinking setting. The constant-on or constant-blinking settings make a pedestrian more visible. However, these features suffer the drawback of being too constant in their pattern. A constant pattern creates the risk of the pattern being ignored after a viewer of the pattern becomes accustomed to the pattern. Therefore, a powered illumination device is needed that provides a variable illumination pattern. Preferably, such a pattern would also indicate the rate of motion of the wearer of the device, which will vary as the motion of the wearer varies.

To improve the alerting effectiveness of a wearable item, other stimulating devices can be used as well, such as a noise making device. A noise making device can bring attention to pedestrians who are not easily seen between parked cars or behind other obstructions such as plants or bus stops. In addition to being a preventive measure to avoid accidents, a noise making device can also act as an alerting device if a pedestrian has encountered trouble. Therefore a wearable item is needed that takes advantage of the benefit of using multiple stimulating devices to increase the profile of a pedestrian.

For a wearable alerting device to be most effective, a pedestrian should wear the item as often as possible. Providing a wearable alerting item that is entertaining and fun to wear will improve the likelihood of a pedestrian wearing such item. Therefore a multiple stimulating device is needed that is pleasurable for the pedestrian to wear, in addition to acting as an alerting device. In particular, such a stimulating device could provide a vibration means to provide a stimulating massage as the pedestrian wears the item.

Furthermore, to improve the likelihood of a pedestrian wearing the alerting item, all the stimulating devices can provide enjoyment, such as an enjoyable sounds and enjoyable decorative lights. Moreover, as humans often become bored with the same item, the stimulating devices should be changeable. Making the stimulating devices changeable not only improves the enjoyment of the wearable item by allowing a pedestrian to choose stimulating devices to their liking, but also provides the ability of using stimulating devices that are later found to be even more effective at alerting others to the pedestrian. Therefore, a wearable stimulating item is needed that can provide the flexibility of using replaceable or interchangeable stimulus means.

In addition to providing safety and entertainment value, a multi-stimulus device can serve an informational function. In order for a stimulus device to be effective, the device must have adequate power. However, if the stimulus device is not easily observed by the wearer of the device, then the wearer may not know if the device has adequate power. The stimulus producing device can be used to alert the user that the device is powered. For example, a vibration device felt by the wearer would provide confirmation that the power source was still functioning. Therefore, a need exists for part of the stimulus device to provide positive feedback to the wearer of the device that the power source is adequate to operate all the stimulus devices of the wearable item.

Therefore, there is a need for a device that that provides a wearable item with a powered illumination device that can provide a variable illumination pattern based on the motion of the wearer to increase visibility of the wearer. Further, the wearable device would provide the benefit of using multiple stimulating devices to increase the profile of the wearer. Such a needed device would be enjoyable to wear to encourage frequent use of the device. Moreover, a stimulating wearable item is needed that can provide the flexibility of replaceable or interchangeable stimulus means and can provide positive feedback to the wearer that the device is working. The present invention accomplishes these objectives.

### SUMMARY OF THE INVENTION

The present device is stimulating wearable item including a wearable item, a stimulus control system, and at least one stimulus means. Preferably, the wearable item is a backpack, though other wearable items could be used, such as a one-strap shoulder bag. Another embodiment of the wearable item is a pet collar. The stimulus control system includes a controller, a motion sensor and at least one power source. Each stimulus means is electrically connected to the stimulus control system. When the controller detects movement of the wearable item through the motion sensor, the stimulus control system activates the at least one stimulus means.

In a preferred embodiment, the stimulus control system further includes at least one socket and the at least one stimulus means further includes a connector, whereby each stimulus means is electrically connected to the stimulus control system by joining each connector to the at least one socket. In one embodiment, the stimulus control system has more than one socket allowing more than one stimulus means to be electrically connected to the stimulus control system.

In a preferred embodiment, the motion sensor is an impact sensor for detecting impact motion, such as occurs when walking. In another preferred embodiment, the controller determines a rate of motion detected by the motion sensor and sets a corresponding activation pattern of the at least one stimulus means.

The at least one stimulus means includes different stimulus means, such as a noise means, a vibration means, or an illumination means. The noise means provides an audible indication that the wearable item is in motion and makes the wearer of the device more noticeable. The vibration means provides an enjoyable “massage” experience to a wearer of the device. The enjoyable experience will encourage a wearer to wear the stimulating wearable item more often. Also, the vibration means provides a confirmation to the wearer that the power source is not depleted. As the rate of motion of the wearer will vary as the wearer increases and decreases motion, the rate of activation of the illumination means will vary. A variable illumination of the device will increase the likelihood of the stimulating wearable item being noticed by other people.

In one embodiment, the stimulus control system and the at least one stimulus means are removably fixed to the wearable item. In an alternate embodiment of the invention, both the stimulus control system and the at least one stimulus means are integrated into the wearable item. In another alternate embodiment of the invention, the stimulus control system is integrated into the wearable item and the at least one stimulus means is removably fixed to the wearable item.

Preferably, each stimulus means is connected directly to the stimulus control system. In one embodiment, the stimulus control system has more than one socket, allowing multiple stimulus means to be connected to the stimulus control system at the same time. In this multiple-socket embodiment, an illumination means, a vibration means, and a noise means can be connected to the stimulus control system at the same time. If desired, other stimulus means can be used together and different combination of stimulus means can be used. Using multiple stimulus means in conjunction with each other will increase the effectiveness of the stimulating wearable item to alert others to the presence of the wearer.

The present device is a wearable item with a powered illumination device that can provide a variable illumination pattern based on the motion of the wearer to increase visibility of the wearer. Further, the wearable device provides the benefit of using multiple stimulating devices to increase the profile of the wearer and is enjoyable to wear encouraging frequent use of the device. Moreover, the stimulating wearable item provides the flexibility of replaceable or interchangeable stimulus means and can provide positive feedback to the wearer that the device is working. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is perspective view of a backpack embodiment of the invention, illustrating a stimulus control system and an illumination means;

FIG. 2 is an exploded perspective view of the stimulus control system;

FIG. 3 is front elevational view of the invention, illustrating a wheeled embodiment;

FIG. 4 is perspective view of a backpack embodiment of the invention, illustrating a stimulus control system with multiple sockets, a vibration means, a noise means, and an illumination means; and

FIG. 5 is a perspective view of a pet collar embodiment of the invention.

### DETAILED DESCRIPTION OF THE PREFERRED EMBODIMENT

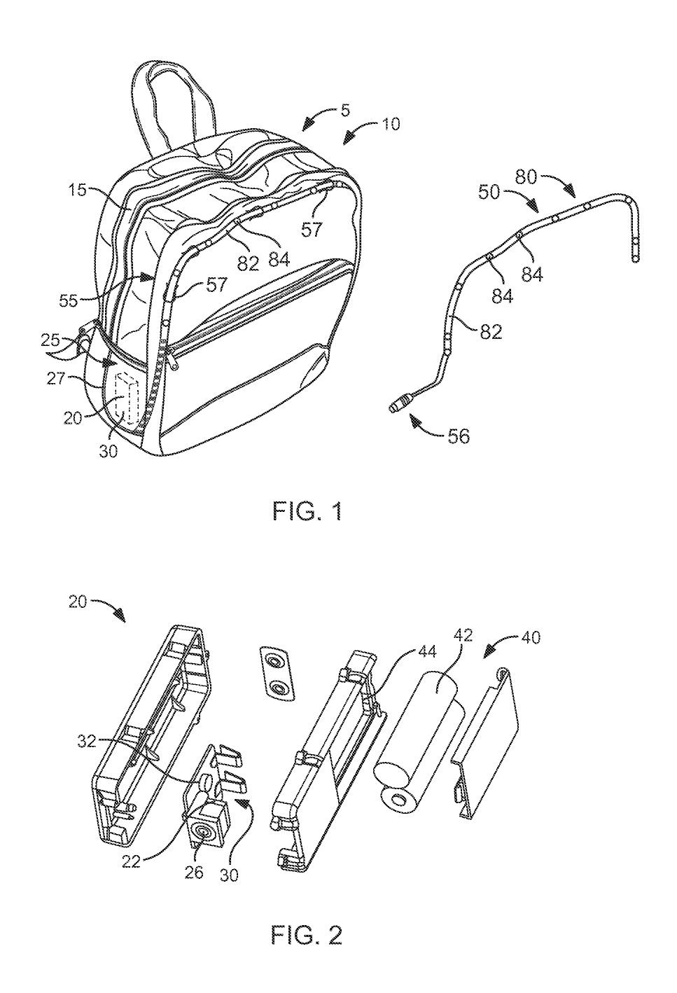

With respect to the drawings, FIG. 1 illustrates a stimulating wearable item 5 including a wearable item 10, a stimulus control system 20, and at least one stimulus means 50. The stimulus control system 20 is fixed to the wearable item 10 with a first attachment means 25, FIG. 1. The first attachment means 25 may include but is not limited to clips, snaps, and hook-and-loop type fasteners. A preferred embodiment of the first attachment means 25 is a pocket 27 (FIG. 1) to fix the stimulus control system 20 to the wearable item 10. As illustrated in FIG. 2, the stimulus control system 20 includes a controller 22, a motion sensor 30 and at least one power source 40.

Illustrated in FIGS. 1 & 3, the at least one stimulus means 50 is fixed to the wearable item 10 with a second attachment means 55. The second attachment means 55 may include but is not limited to clips, snaps, and hook-and-loop type fasteners. In a preferred embodiment, the second attachment means 55 includes at least one clip 57 (FIG. 1) to fix the at least one stimulus means 50 to the wearable item 10. Each stimulus means 50 is electrically connected to the stimulus control system 20. When the controller 22 detects movement of the wearable item 10 through the motion sensor 30, the stimulus control system 20 activates the at least one stimulus means 50.

In a preferred embodiment, the stimulus control system 20 further includes at least one socket 26 (FIG. 2) and the at least one stimulus means 50 further includes a connector 56 (FIG. 1), whereby each stimulus means 50 is electrically connected to the stimulus control system 20 by joining each connector 56 to the at least one socket 26. In one embodiment illustrated in FIG. 4, the stimulus control system 20 has more than one socket 26 allowing more than one stimulus means 50 to be electrically connected to the stimulus control system 20.

In the embodiment illustrated in FIG. 2, the at least one power source 40 is a battery 42 contained in a battery enclosure 44. In a preferred embodiment, the motion sensor 30 is an impact sensor 32 (FIG. 2) for detecting impact motion, such as occurs when walking. In a preferred embodiment, the controller 22 determines a rate of motion detected by the motion sensor 30 and sets a corresponding activation pattern of the at least one stimulus means 50. In another preferred embodiment, the controller 22 deactivates the at least one stimulus means 50 after a predetermined period of time of detecting substantially no motion.

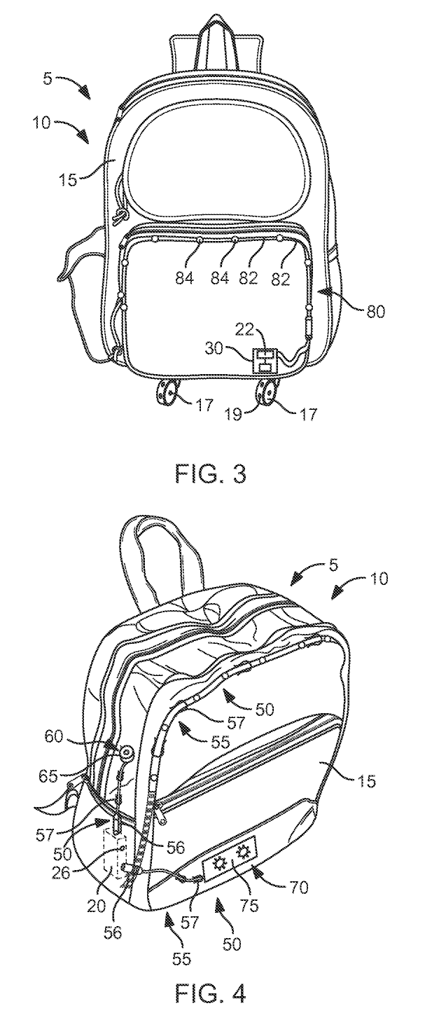

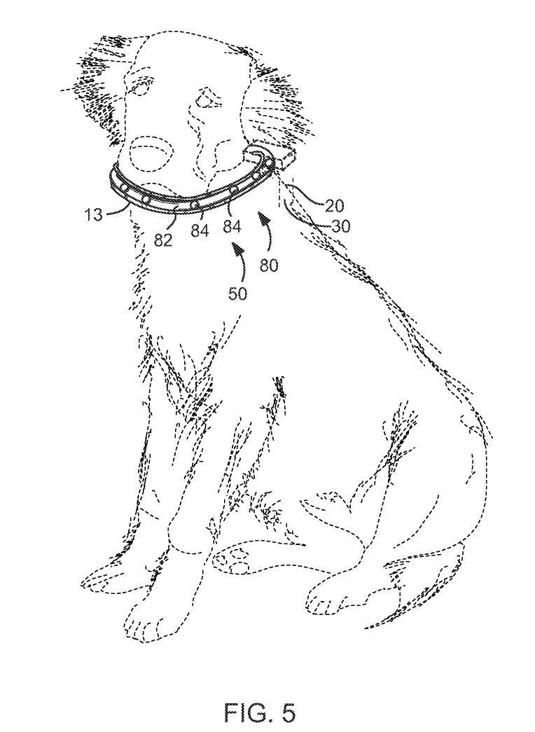

In a preferred embodiment illustrated in FIG. 1, the wearable item 10 is a backpack 15. Preferably, the backpack 15 is hand or machine washable. In another embodiment, the wearable item 10 can be a one-strapped shoulder bag (not shown) or a pet collar 13 (FIG. 5). In an embodiment illustrated in FIG. 3, the backpack 15 further includes at least one wheel 17, wherein the motion sensor 30 is adapted to detect rotational movement of the at least one wheel 17. In one embodiment, the at least one wheel 17 includes at least one magnet 19 (FIG. 3) in the outer radius of the at least one wheel 17. As the at least one wheel 17 proximate to the stimulus control system 20 makes a rotation, the controller 22 detects rotation of the at least one magnet 19 and accordingly activates each stimulus means 50. As the rotation speed of the wheel 17 increases, the frequency of activation of each stimulus means 50 increases as well.

In one embodiment illustrated in FIG. 4, the at least one stimulus means 50 is a noise means 60. In one embodiment, the noise means 60 is a simple electrical beeping device 65 (FIG. 4) that beeps when activated by the controller 22. As the controller 22 detects motion of the wearable item 10 via the motion sensor 30, the controller 22 activates the noise means 60 with a corresponding rate of activation. Therefore, as detection of the rate of motion of the wearable item 10 increases the rate of activation of the noise means 60 increases, providing an audible indication that the wearable item 10 is in motion and an audible indication of the rate of motion of the wearable item 10.

In an alternate embodiment, the at least one stimulus means 50 is a vibration means 70 (FIG. 4). Preferably, the vibration means 70 is a vibration device 75 (FIG. 4) that causes vibration using an offset weight that spins by a motor and the rotation of the offset weight causes the device to oscillate back and forth creating a vibration effect. Moving while wearing the stimulating wearable item 5 activates the motion sensor 30 and provides an enjoyable “massage” experience to a wearer of the device. The enjoyable experience will encourage a wearer to wear the stimulating wearable item 5 more often. Also, the vibration means 70 provides a confirmation to the wearer that the power source 40 is not depleted.

In another alternate embodiment, the at least one stimulus means is an illumination means 80 (FIGS. 1 & 4). In a preferred embodiment illustrated in FIGS. 1 and 5, the illumination means comprises a tube 82 and at least one LED 84 fixed within the tube 82. The illumination means 80 can be manufactured with LEDs 84 in a variety of different shapes and colors. As the controller 22 detects motion of the wearable item 10 via the motion sensor 30, the controller 22 activates the illumination means 80 with a corresponding rate of activation. As the rate of motion of the wearer will vary as the wearer increases and decreases motion, the rate of activation of the illumination means 80 will vary. A variable illumination of the stimulating wearable item 5 will increase the likelihood of the stimulating wearable item 5 being noticed by other people.

In one embodiment, the stimulus control system 20 is removably fixed to the wearable item 10 with a first attachment means 25. In another embodiment, the at least one stimulus means 50 is removably fixed to the wearable item 10 with a second attachment means 55, with each stimulus means 50 removably electrically connected to the stimulus control system 20. In an alternate embodiment of the invention, the stimulus control system 20 is integrated into the wearable item 10, preferably being sewn into the wearable item 10. In another alternate embodiment of the invention, both the stimulus control system 20 and the at least one stimulus means 50 are integrated into the wearable item 10, preferably being sewn into the wearable item 10.

Preferably, each stimulus means 50 is connected directly to the stimulus control system 20. In one embodiment illustrated in FIG. 4, the stimulus control system 20 has more than one socket 26, allowing multiple stimulus means 50 to be connected to the stimulus control system 20 at the same time. In this multiple-socket embodiment, an illumination means 80, a vibration means 70, and a noise means 60 can be connected to the stimulus control system 20 at the same time (FIG. 4). If desired, other stimulus means 50 can be used together and different combination of stimulus means 50 can be used. Using multiple stimulus means 50 in conjunction with each other will increase the effectiveness of the stimulating wearable item 5 to alert others to the presence of the wearer of the stimulating wearable item.

The above multiple-socket embodiment of the stimulus control system 20 provides many advantages. Additional stimulus means 50 can be added to the stimulating wearable item 5 by connecting the connector 56 of each additional stimulus means to an unconnected socket 26 of the stimulus control system 20. Likewise, a stimulus means 50 can be easily disconnected from the stimulating wearable item 5. In the embodiment where the at least one stimulus means 50 is removably fixed to the wearable item 10, a stimulus means 50 can be removed completely from the stimulating wearable item 5. Similarly, in the embodiment where the at least one stimulus means 50 is removably fixed to the wearable item 10 with a second attachment means 55, additional stimulus means 50 can be secured to the wearable item 10 using the second attachment means 55. The ease of adding and removing each stimulus means 50 allows a wearer of the invention to customize the stimulating wearable item 5 as desired.

In an alternate embodiment (not shown), multiple stimulus means can be connected in series, with each stimulus means 50 having a connector 56 at one end and a socket (not shown) at a distal end. In the series embodiment, an initial stimulus means 50 would be connected to the socket 26 of the stimulus control system 20 and additional stimulus means 50 would be connected in series to the socket (not shown) of the initial stimulus means 50.

While a particular form of the invention has been illustrated and described, it will be apparent that various modifications can be made without departing from the spirit and scope of the invention. For example, the at least one stimulus means 50 can include a heating means or a smell producing means (not shown). Also, the first attachment means 25 and the second attachment means 55 can comprise of magnetic fasteners. Accordingly, it is not intended that the invention be limited, except as by the appended claims.

What is claimed is:

1. A stimulating wearable item comprising:
a wearable item;
a stimulus control system fixed to the wearable item with a first attachment means and including a controller, a motion sensor, and at least one power source;
at least one stimulus means fixed to the wearable item with a second attachment means, each stimulus means electrically connected to the stimulus control system;
whereby when the controller detects movement of the wearable item through the motion sensor, the stimulus control system activates the at least one stimulus means.

2. The device of claim 1 wherein the stimulus control system further includes at least one socket and the at least one stimulus means further includes a connector, whereby each stimulus means is electrically connected to the stimulus control system by joining the connector to the at least one socket.

3. The device of claim 1 wherein the motion sensor is an impact sensor for detecting impact motion.

4. The device of claim 1 wherein the wearable item is a backpack.

5. The device of claim 4 wherein the backpack further includes at least one wheel, and wherein the motion sensor is adapted to detect rotational movement thereof.

6. The device of claim 1 wherein the controller determines a rate of motion detected by the motion sensor and sets a corresponding activation pattern of the at least one stimulus means.

7. The device of claim 1 wherein the controller deactivates the at least one stimulus means after a predetermined period of time of detecting substantially no motion.

8. The device of claim 1 wherein the at least one stimulus means is a noise means.

9. The device of claim 1 wherein the at least one stimulus means is a vibration means.

10. The device of claim 1 wherein the at least one stimulus means is an illumination means.

11. The device of claim 10 wherein the at least one illumination means comprises a tube and at least one LED fixed within the tube.

12. The device of claim 1 wherein the stimulus control system is removably fixed to the wearable item with a first attachment means.

13. The device of claim 1 wherein the at least one stimulus means is removably fixed to the wearable item with the second attachment means, each stimulus means removably electrically connected to the stimulus control system.

14. A stimulating wearable item comprising:
a wearable item;
a stimulus control system integrated with the wearable item and including a controller, a motion sensor, and at least one power source;
at least one stimulus means removably fixed to the wearable item with an attachment means, each stimulus means removably electrically connected to the stimulus control system.
whereby when the controller detects movement of the wearable item through the motion sensor, the stimulus control system activates the at least one stimulus means.

15. A stimulating wearable item comprising:
a wearable item;
a stimulus control system integrated with the wearable item and including a controller, a motion sensor, and at least one power source;
at least one stimulus means integrated with the wearable item, each stimulus means electrically connected to the stimulus control system;
whereby when the controller detects movement of the wearable item through the motion sensor, the stimulus control system activates the at least one stimulus means.
